(19) United States
(12) Patent Application Publication
(10) Pub. No.: US 2011/0164283 A1
(43) Pub. Date: Jul. 7, 2011

(54) IMAGE PROCESSING APPARATUS, IMAGE PROCESSING SYSTEM, AND IMAGE PROCESSING METHOD

(76) Inventors: Tamon Sadasue, Tokyo (JP); Yuka Kihara, Yokohama (JP)

(21) Appl. No.: 12/976,133

(22) Filed: Dec. 22, 2010

(30) Foreign Application Priority Data
Jan. 6, 2010 (JP) 2010-001468

(51) Int. Cl. G06K 15/02

(52) U.S. Cl. 358/1.16; 358/1.18

(57) ABSTRACT

An image processing apparatus having an image data storing unit configured to store image data, an image data receiving unit configured to receive image data scanned the image forming apparatus, and to store the image data to the image data storing unit. There is a layout generation unit configured to generate layout information for arranging the plural image data in the image data storing unit according to a rule, a layout image generation unit configured to generate a layout image data arranged the image data according to the layout information if a certain output condition is satisfied, and a print control unit configured to cause the image forming apparatus to print the layout image data.

### BACKGROUND OF THE INVENTION

1. Field of the Invention

The present invention relates to an image processing apparatus, an image processing system, an image processing method.

2. Description of the Related Art

In recent years, when copying originals using a copy machine, a printed page is outputted corresponding to each original page. On the other hand, plural originals can be printed on one page using N-up printing, if it is not necessary to have one image per sheet. As a result, it is possible to reduce paper and toner consumption, and to increase portability (see, for example, Japanese Laid-Open Patent Application No. 2007-150698).

However, there are some restrictions to using N-up printing. For example, the size of the print is reduced. If it does not necessarily consider page numbers or arrangement substance included the original, further improvement may be needed.

### SUMMARY OF THE INVENTION

The present invention provides an image processing apparatus, an image processing system and, an image forming method in which one or more of the above-described disadvantages are eliminated.

A preferred embodiment of the present invention provides an image processing apparatus, an image processing system, and an image processing method with which a simple mechanism is implemented for generating a layout image based on plural image data that is provided by collaboration of an image forming apparatus and an external application.

According to an aspect of the present invention, there is provided an image processing apparatus that is connected to an image forming apparatus via the network system comprising an image data storing unit configured to store image data, an image data receiving unit configured to receive image data scanned by the image forming apparatus and to store the image data to the image data storing unit, a layout generation unit configured to generate layout information for arranging the plural image data in the image data storing unit according to a rule, a layout image generation unit configured to generate layout image data arranged the image data according to the layout information if an output condition is satisfied, and a print control unit configured to cause the image forming apparatus to print the layout image data.

According to an aspect of the present invention, there is provided an image processing system comprising: an image forming apparatus, an image forming application in a apparatus, wherein the image forming application includes an image data storing unit configured to store image data, an image data receiving unit configured to receive image data scanned by the image forming apparatus and to store the image data to the image data storing unit, a layout generation unit configured to generate layout information for arranging the plural image data in the image data storing unit according to a rule, a layout image generation unit configured to generate a layout image data arranged the image data according to the layout information if an output condition is satisfied, and a print control unit configured to cause the image forming apparatus to print the layout image data.

According to an aspect of the present invention, there is provided an image processing apparatus method executed by an image processing apparatus which includes the steps of receiving image data scanned by the image forming apparatus, storing the image data, generating layout information for arranging the stored plural image data according to a rule, generating layout image data arranged according to the layout information if a certain output condition is satisfied, and causing the image forming apparatus to print the layout image data.

According to one embodiment of the present invention, an image forming apparatus, an image processing system, and image processing method, and a recording medium are provided, with which a simple mechanism is implemented for generate layout image based on plural image data that is provided by collaboration of an image forming apparatus and an external application.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of an information processing system according to an embodiment of the present invention;

FIG. 2 illustrates a hardware configuration of the image forming apparatus 10 according to an embodiment of the present invention;

FIG. 3 illustrates a hardware configuration example of a user terminal of the present embodiment;

FIG. 4 illustrates a functional configuration of the widget 21, the widget manager 22, and the provider application 1221;

FIG. 5 is a sequence diagram for describing processing procedures performed when sending the widget information of a scan layout widget 21a;

FIG. 6 illustrates an example of widget information of the scan layout widget 21a;

FIG. 7 illustrates an example of the user management table 136;

FIG. 8 is a sequence diagram for describing a processing procedures performed when executing a process flow of the scan layout widget 21a;

FIG. 9 illustrates an example of a displayed user selection screen page;

FIG. 10 illustrates a configuration of the widget information of the scan layout widget 21a sent from the widget manager 22 to the image forming apparatus 10;

FIG. 11 illustrates an example of a displayed widget selection screen page;

FIG. 12 illustrates example functional structures of the logic unit 214a of the scan layout widget;

FIG. 13 is a flowchart showing processing procedures in a logic unit of the scan layout widget;

FIG. 14 illustrates a first example of a process to extract a piece of image data;

FIGS. 15A and 15B illustrate a second example of a process to extract a piece of image data;

FIG. 16 illustrates an outline of a process to generate layout information;

FIG. 17 is a flowchart showing processing procedures for generating layout information;

FIG. 18 is a flowchart showing processing procedures for arranging data employing a FFDH algorithm;

FIG. 19 illustrates an example of close-packed layout information of image data.

FIG. 20 illustrates an example of blocks and rows based on arranging image data on an arrangement area;

FIG. 21 is a flowchart showing processing procedures in which a page layout is output;

FIG. 22 illustrates an example of a block across a two-page area;

FIG. 23 is a flowchart showing processing procedures when outputting a page layout;

FIG. 24 illustrates an example of bringing forward the other block when a certain block is across a page partition;

FIG. 25 is a sequence diagram which shows processing procedures performed when registering the widget information of the print widget 21b;

FIG. 26 illustrates an example of widget information of the print widget 21b;

FIG. 27 illustrates an example of a displayed widget selection screen page when registering the print job for the print widget 21b; and

FIG. 28 is a sequence diagram showing the process of the print widget 21b.

### DETAILED DESCRIPTION OF THE PREFERRED EMBODIMENTS

A description is given, with reference to the accompanying drawings, of embodiments of the present invention.

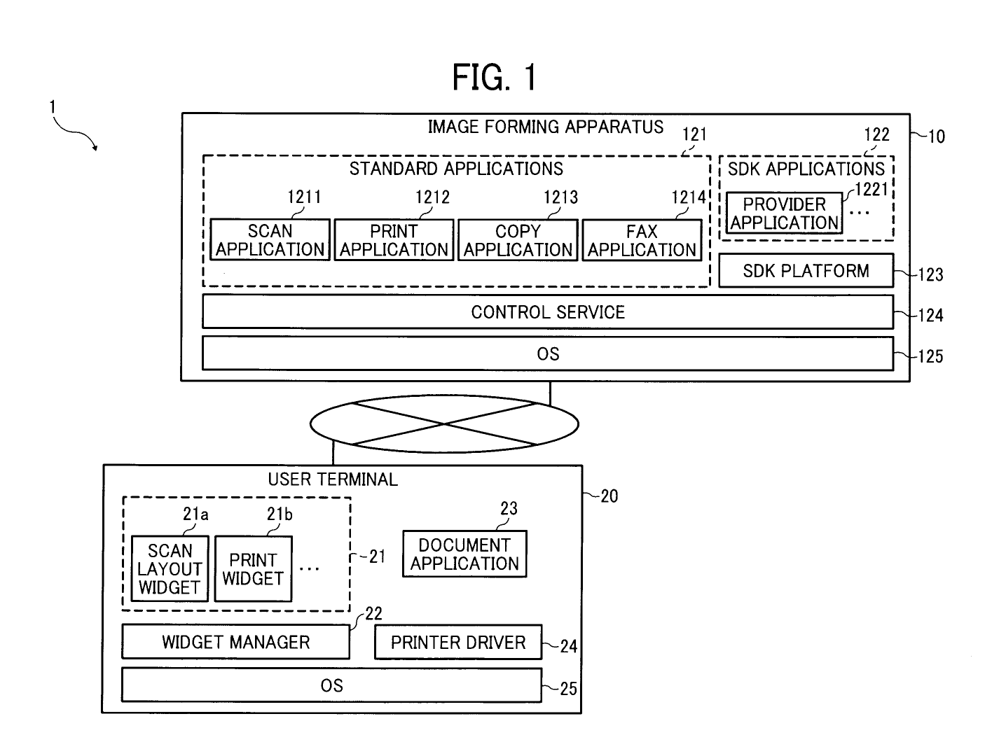

FIG. 1 illustrates a configuration of an information processing system 1 according to an embodiment of the present invention. The image forming system 1 includes at least one image forming apparatus 10, at least one user terminal 20.

The image forming apparatus 10 is a multifunction peripheral for implementing plural functions (image forming functions) in a single unit such as printing, scanning, copying, and fax transmission functions. According to the present embodiment, the image forming apparatus 10 is a device for implementing both scanning and printing functions. However, the image forming apparatus 10 may be a device for implementing one function (e.g., a printer, a scanner, a copier, or a fax machine). In this case, other image forming apparatuses 10 included the image forming system 1 may complement a function not implemented in the image forming apparatus.

The user terminal 20 is a personal terminal used by a user, in which software programs can be installed and executed. The user terminal 20 is not limited to any particular device as long as it has a communications function. Examples of the user terminal 20 are information processing devices such as a desktop PC (Personal Computer), a notebook PC, a PDA (Personal Digital Assistance), and a mobile phone.

The user terminal 20 includes a scan layout widget 21a, a print widget 21B, a widget manager 22, a document application 23, a printer driver 24 and an OS 25. In the present embodiment, the scan layout widget 21a, and the print widget 21B are application programs that may be collectively referred to as widgets 21. In recent years, simple and convenient applications referred to as widgets or gadgets have been available in the market. In the present embodiment, the widgets 21 generally refer to software applications that can be easily and conveniently installed and used (thus, the technical scope is not limited by the term “widget”). In the present embodiment, the widgets 21 have a common characteristic in that they use services provided by the image forming apparatus 10 or services provided in the network 70 to control predetermined process flows.

The scan layout widget 21a causes the image forming apparatus 10 to execute a scanning process, and saves the image data obtained as a result of the scanning process in the user terminal 20. Next, the scan layout widget 21a generates a layout of plural image data which has been stored, and generates image data arranging the plural image data based in a certain layout. The image data arranging the plural image data means, for example, two-dimensional image data which can be formed on or sent to a display unit or a print medium by a computer. However the term ‘image’ includes not only formed data on a display unit or a print medium but also image data stored in a memory.

The print widget 21b causes the image forming apparatus 10 to print out document data that is saved in the user terminal 20.

The widget manager 22 serves as a framework of the widgets 21, and mediates communications between the widgets 21 and the image forming apparatus 10. Each of the widgets 21 are provided with an interface and a processing procedure specified by the widget manager 22. That is to say, the widgets 21 according the present embodiment are applications that operate in collaboration with the widget manager 22.

The document application 23 includes an application for producing document data to be printed such as word processor software or spreadsheet software. Plural document applications 23 depending on data format are installed in the user terminal 20.

The printer driver 24 generates print data related to the document data generated by the document application 23. When a logical printer corresponding to the print widget 21b is designated a destination of print, the printer driver 24 generates an intermediate file having a predetermined file name which is set up as an output destination to the logical printer.

The OS 25 is a typical operating system, and may be implemented as a Linux, Unix, or Microsoft Windows operating system, for example. Software items in the user terminal 20 operate as processes or threads on the OS 25.

The image forming apparatus 10 includes standard applications 121, an SDK (software development kit) application 122, an SDK platform 123, a control service 124, and an OS 125.

The standard applications 121 are an assembly of applications that are pre-installed in the image forming apparatus 10 as standard features (the image forming apparatus 10 is shipped with the standard applications 121). In FIG. 3, the examples of the standard applications 121 are a scan application 1211, a print application 1212, a copy application 1213, and a fax application 1214. The scan application 1211 executes a scan job. The print application 1212 executes a print job. The copy application 1213 executes a copy job. The fax application 1214 executes a fax transmission job or a fax reception job.

The control service 124 is a group of software modules for providing functions for controlling various hardware resources for applications. For example, the control service 124 has a function relevant to network communications, a function for controlling the scanner, a function for controlling the printer, and a function for managing memories.

The SDK applications 122 may be further installed in the image forming apparatus 10 after shipment as plug-ins for expanding functions of the image forming apparatus 10. A provider application 1221 is illustrated as an example of the SDK application 122. The provider application 1221 executes a process for making the widgets 21 operable by the image forming apparatus 10, and a process for causing the image forming apparatus 10 to execute a process requested by the widgets 21.

The SDK platform 123 provides an environment for executing the SDK applications 122. The SDK applications 122 are developed with the use of an API (Application Program Interface) provided by the SDK platform 123. For example, the SDK platform 123 provides the SDK applications 122 with an interface for using a scanning function, an interface for using a printing function, and an interface for using the copy function. The API of the SDK applications 122 are publically available, or a third party vendor may develop the SDK applications 122.

The OS 125 is a typical operating system. Software items in the image forming apparatus 10 operate as processes or threads on the OS 125.

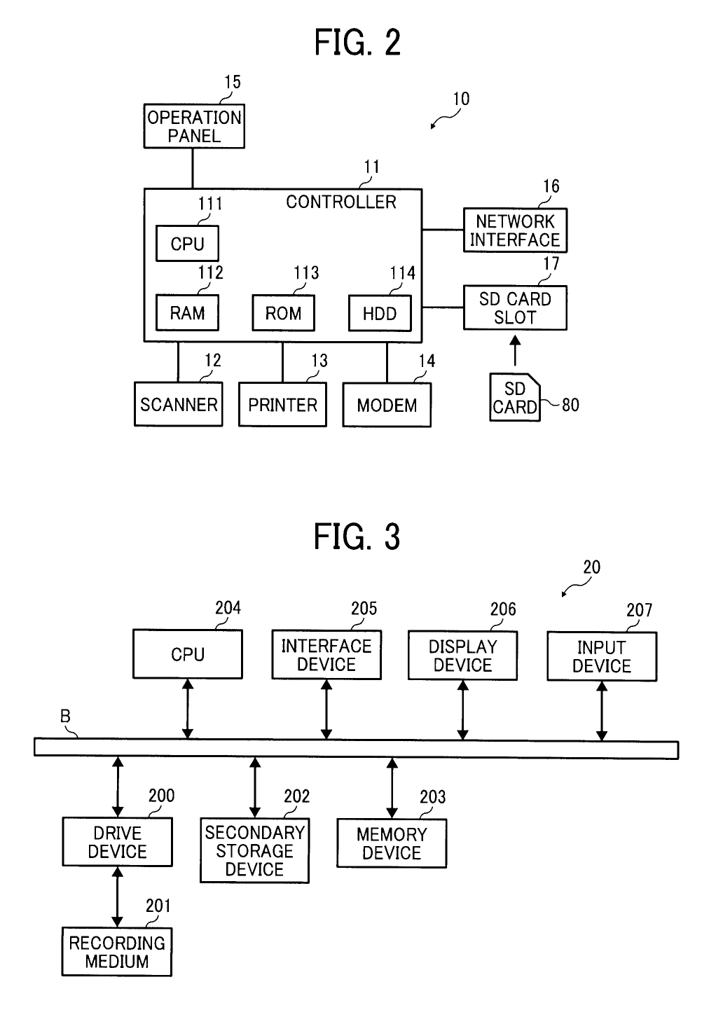

FIG. 2 illustrates a hardware configuration of the image forming apparatus 10 according to an embodiment of the present invention. As shown in FIG. 2, the image forming apparatus 10 includes hardware elements such as a controller 11, a scanner 12, a printer 13, a modem 14, an operation panel 15, a network interface 16, and an SD card slot 17.

The controller 11 includes a CPU 111, a RAM 112, a ROM 113, and a HDD 114. The ROM 113 records various programs and data used by the programs. The RAM 112 is used as a storage area for loading programs and a work area for the loaded programs. The CPU 111 processes the programs loaded in the RAM 112 to implement various functions. The HDD 114 records programs and various data items used by the programs.

The scanner 12 is a hardware element for scanning an original sheet or page to obtain image data. The printer 13 is a hardware element for printing data onto a sheet. The modem 14 is a hardware element for connecting the image forming apparatus 10 to a telephone line to transmit and receive image data by fax communications. The operation panel 15 is a hardware element including an input unit such as a pointer for receiving input from a user, and a display unit such as a liquid crystal panel. The network interface 16 is a hardware element for connecting the image forming apparatus 10 to a network (wired or wireless) such as LAN. The SD card slot 17 is used for reading and/or writing programs and data such as document or image data recorded in an SD card 80. In the image forming apparatus 10, in addition to programs recorded in the ROM 113, programs recorded in the SD card 80 may also be loaded and executed in the RAM 112. It is to be noted that the SD card 80 may be replaced with other recording media (e.g., CD-ROM or a USB (Universal Serial Bus) memory). That is, the type of recording medium equivalent to the SD-card 80 is not to be limited in particular. In this case, the SD-card slot 17 may be replaced with hardware corresponding to the type of recording medium.

FIG. 3 illustrates a hardware configuration example of a user terminal 20 of the present embodiment. Referring to FIG. 3, the user terminal 20 includes a drive device 200, a secondary storage device 202, a memory device 203, a CPU 204, an interface device 205, a display unit 206, and an input unit 207, which are mutually connected by a bus B.

A program realizing processes in the delivery server 20 is supplied by a recording medium 201 such as CD-ROM, SD card, or other memory device. When the recording medium 201 with the program recorded on it is installed in the drive device 200, the program is installed in the secondary storage device 202 via the drive device 200. However, the program needs not to be always installed from the recording medium 201 and may be downloaded from another computer via the network. The secondary storage device 202 stores necessary files, data and so on in addition to the installed program.

The memory device 203 receives or reads out the program from the secondary storage device 202 when the program is instructed to be executed and stores the program in the memory device 203. The CPU 204 realizes a function related to the user terminal 20a in conformity with the program stored in the memory device 203. The interface unit 205 includes one or more various communication interfaces, such as an interface for the network communication, an interface for a USB (Universal Serial Bus) connection, and an interface for wireless communication such as Bluetooth, a wireless network, and the like. The display unit 206 displays GUIs (Graphical User Interfaces) or the like by each program and may be implemented as a LCD, for example. The input unit 207 includes a pointing device, a keyboard, a mouse, or buttons or the like, and is used to input various operating instructions.

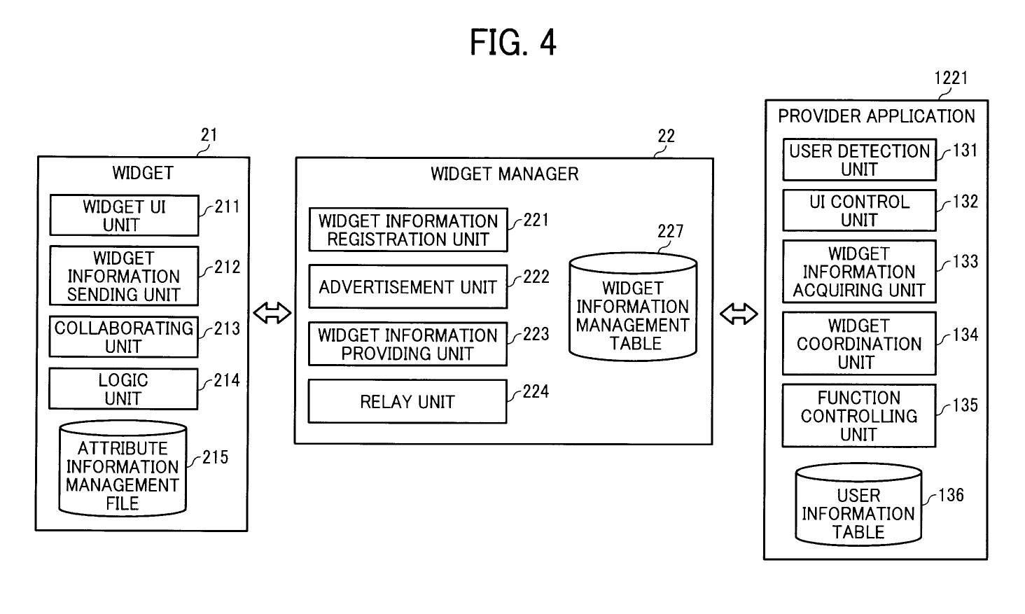

Next, a detailed description is given of the widgets 21, the widget manager 22, and the provider application 1221. FIG. 4 illustrates a functional configuration of one of the widgets 21, the widget manager 22, and the provider application 1221. As shown in FIG. 4, each widget 21 includes a widget UI unit 211, a widget information sending unit 212, a collaborating unit 213, a logic unit 214, and an attribute information management file 215.

The widget UI unit 211 causes a display device of the user terminal 20 to display various screen pages relevant to the widget 21. The widget information sending unit 212 sends a request to register widget information to the widget manager 22, when the widget 21 is executed. The widget information includes information necessary for executing the widget 21 (for example, an identifier of widget 21). The collaborating unit 213 controls communications (exchange of information) between the widget 21 and the provider application 1221. The attribute information management file 215 is a file for storing attribute information for the widget 21. The attribute information includes setting information for the widget 21. The setting information includes collections of parameter for behaviors of widget 21 or process flow performed by widget 21. The logic unit 214 is where a function unique to each widget 21 is installed. For example, a logic unit 214 of the scan layout widget 21a generates an image data arranging the plural image data based on a layout. A logic unit 214 of the print widget 21b cause the image forming apparatus 10 to carry out a print job corresponding to print data (intermediate file) outputted to logical printers.

If a port of the widget needs to distinguish between the scan layout widget 21a and the print widget 21b, the port of widget of the scan layout widget 21a adds suffixed ‘a’, and the other one adds suffixed ‘b’. For example, a logic unit 214 of the scan layout widget 21a indicates ‘logic unit 214a’.

The widget manager 22 includes a widget information registration unit 221, an advertisement unit 222, a widget information providing unit 223, a relay unit 224, and a widget information management table 227.

The widget information registration unit 221 receives a request to register widget information from the widget 21, and saves the widget information in the widget information management table 227. The widget information management table 227 includes widget information of the widgets 21 that are activated in the user terminal 20. The widget information management table 227 is generated in the storage device of the user terminal 20.

The advertisement unit 222 advertises (broadcasts or multicasts), on the network, a user ID included in widget information received by the widget information registration unit 221. The advertisement is issued in units of users (in units of user IDs). Specifically, assuming that an advertisement relevant to a user A has been issued in response to the activation of a certain widget in the user terminal 20, when another subsequent widget 21 is activated in the same user terminal 20, an advertisement relevant to such widget information is not issued. In the present embodiment, as a matter of convenience, it is assumed that each user terminal 20 corresponds to one user. Therefore, it can be said that an advertisement issued by the advertisement unit 222 is information to report to the image forming apparatus 10 that there is a new user that can use one of the widgets 21. In another example, the advertisements may be issued in units of widget information items. In this case, plural advertisements may be redundantly issued for the same user; however, the image forming apparatus 10 may eliminate such redundancy.

The widget information providing unit 223 sends widget information registered in the widget information management table 227 to the image forming apparatus 10, in response to a request from the image forming apparatus 10. The relay unit 224 relays communications between the widget 21 and the provider application 1221.

The provider application 1221 includes a user detection unit 131, a UI control unit 132, a widget information acquiring unit 133, a widget coordination unit 134, a function control unit 135 and a user management table 136.

The user detection unit 131 detects the presence of a user who can use the widget 21 based on an advertisement issued by the widget manager 22, and registers, in the user management table 136, a user ID included in the advertisement. The user management table 136 is for managing a list of users that are executing the widgets 21 on the network.

The UI control unit 132 receives input of an instruction to operate the widget 21 from a user. The widget 21 is located in the user terminal 20, but the widget 21 may be operated from the operation panel 15 of the image forming apparatus 10. The widget information acquiring unit 133 acquires, from the widget manager 22, widget information of the widget 21 belonging to a user selected as an execution target among users registered in the user management table 136. The widget coordination unit 134 coordinates communications to widget manager 21. The function control unit 135 carries out a control of a function requested to the image forming apparatus 10 by the widget 21. Processes to realize functions are delegated to the standard application 121 or the SDK application 122.

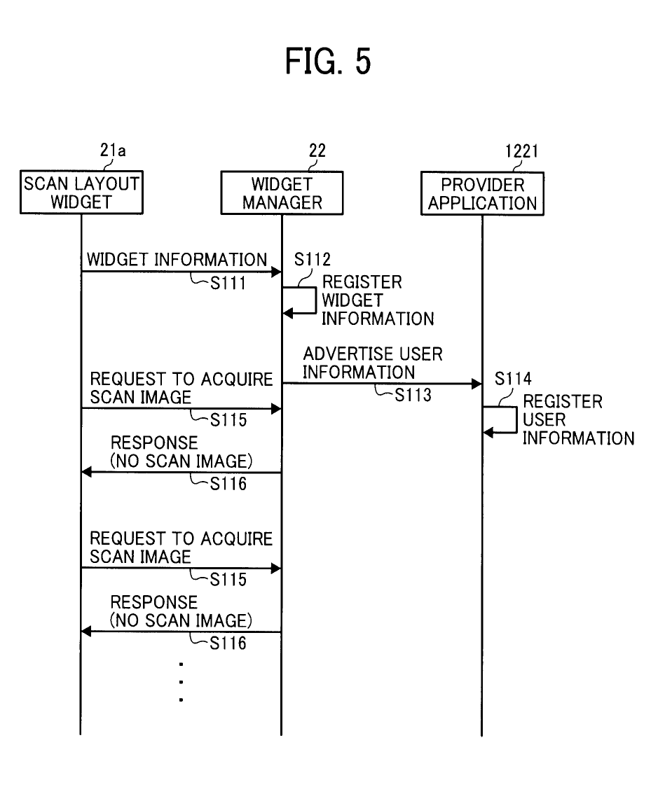

A description is given of a process performed by the image forming system 1. FIG. 5 is a sequence diagram which illustrates processing procedures performed when sending the widget information of a scan layout widget 21a.

When the scan layout widget 21a is activated in response to an instruction input by a user, the scan layout widget 21a acquires widget information from the attribute information management file 215a and sends the widget information piece to the widget manager 22 (step S111). In advance, each widget 21 stores an identifier to communicate with the widget manager 22 (for example, URL (Uniform Resource Locator) of the widget manager 22).

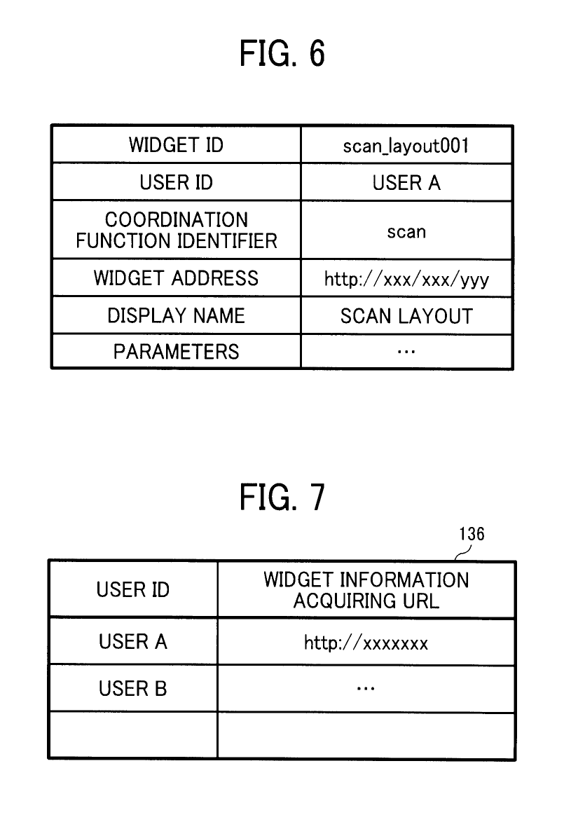

FIG. 6 illustrates an example of widget information of the scan layout widget 21a. As shown in FIG. 6, the widget information of the scan layout widget 21a includes a widget ID, a user ID, a coordination function identifier, a widget address, a display name, and parameters.

The widget ID is identification information for uniquely identifying each widget 21. The user ID is an identification of a user of the widget 21. The coordination function identifier is information for recognizing a function included in the image forming apparatus 10 coordinated with the widget 21 (that is to say, a function which is used by the scan layout widget 23a). Examples of the coordination function identifier are “print” and “scan”. “Print” indicates a print function. “Scan” indicates a scan function. The scan layout widget 21a uses the scan function of the image forming apparatus 10. Therefore, in the example shown in FIG. 6, “scan” is indicated as the coordination function identifier. The widget address is identification information (for example, a URL) for uniquely identifying each widget 21 in network communications. The display name is a character string for displaying the scan layout widget 21a.

The parameters are used to determine the behavior corresponding to each widget 21. For example, the parameter of the scan layout widget 21a includes scan setting information (for example, resolution, color or black-and-white).

The widget information from the scan layout widget 21a is received by the widget information registration unit 221 of the widget manager 22 shown in FIG. 4. The widget information registration unit 221 registers the widget information in the widget information management table 227 corresponding to a user ID included in the widget information. When there is no widget information management table 227 that corresponds to the user ID, the widget information registration unit 221 generates the widget information management table 227 corresponding to the user ID, and registers the widget information in the generated widget information management table 227 (step S112).

When a new widget information management table 227 is generated (that is to say, when widget information is registered for the first time for the user corresponding to the user ID included in the received widget information), the advertisement unit 222 of the unit manager 22 issues an advertisement including the user ID, and a URL for acquiring widget information included in the received widget information onto a network (S113).

The URL for acquiring widget information (hereinafter, “widget information acquiring URL”) is unique to each the widget information management table 227. For example, the widget information registration unit 221 generates the widget information acquiring URL corresponding to the widget information management table 227, when the widget information registration unit 221 generates the widget information management table 227 for each of the users. Therefore the widget information acquiring URL is unique to each user terminal 20.

FIG. 7 illustrates an example of the user management table 136. As shown in FIG. 7, the user management table 136 manages pairs of user IDs and the widget information acquiring URLs. The example shown in FIG. 7 includes records registered for user A and user B. The user management table 136 may be stored in the HDD 114.

The scan layout widget 21a performs polling to the widget manager 22 to confirm whether image data has been obtained by a scanning process at the image forming apparatus 10 after widget information is issued. Specifically, the collaborating unit of the scan layout widget 21a sends a request to acquire image data obtained by a scanning process (scan image data) to the relay unit 224 of the widget manager 22 (step S115). The relay unit 224 responds to the acquiring request (step S116). Image data is not obtained by a scanning process at this point, and therefore a response indicating that there is no scan image data is returned from the relay unit 224. After, the request to acquire the scan image data is performed at certain intervals. The request to acquire the scan image data may include the widget ID.

After, the scan layout widget 21a is activated in the user terminal 20, the user moves to the location where the image forming apparatus 10 is installed to operate the scan layout widget 21a. When plural image forming apparatuses 10 are able to communicate with the user terminal 20, each user detection unit 131 of the image forming apparatus 10 receives the advertisement to registers the user ID and the widget information acquiring URL to each user management table 136 in the plural image forming apparatuses 10. Therefore, the user can execute the scan layout widget 21a in any of plural image forming apparatuses 10 receiving the same advertisement.

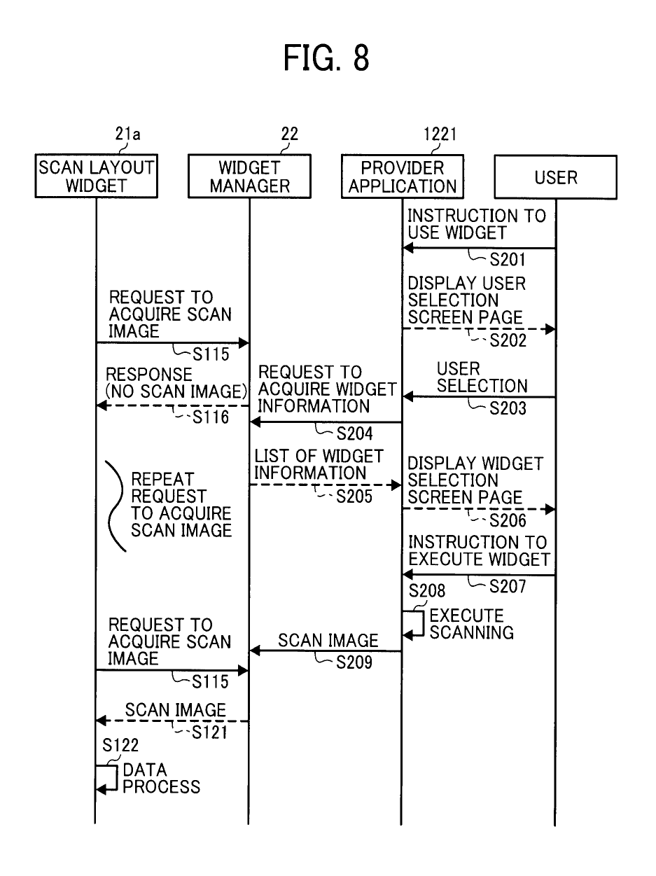

Next, a description is given of an executed process according to user operation of the image forming apparatus 10. FIG. 8 is a sequence diagram for describing processing procedures performed when executing a process flow of the scan layout widget 21a.

When a user inputs an instruction to use the provider application 1221 via the operation panel 15 (step S201), UI control unit 132 of the provider application 1221 causes the operation panel 15 to display a user selection screen page based on user management table 136 (step S202).

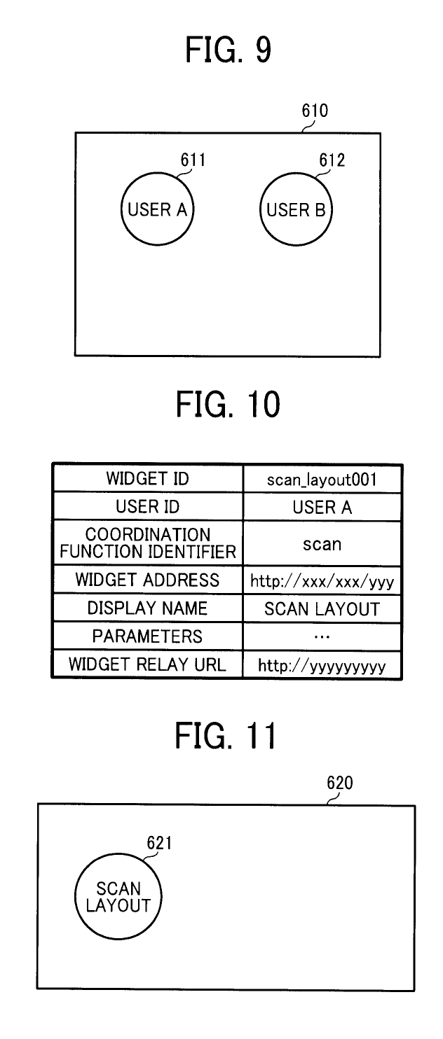

FIG. 9 illustrates an example of a displayed user selection screen page. A user selection screen page 610 shown in FIG. 9 includes buttons that each correspond to a user ID. In FIG. 9, a button 611 corresponding to a user A and a button 612 corresponding to a user B are displayed.

Next, the user presses the button corresponding to his or her own user ID in the user selection screen page 610 (step S203). As the button is pressed, the widget information acquiring unit 133 acquires, from the user management table 136, a widget information acquisition URL that is associated with the user ID corresponding to the selected button. User authentication may be performed as the button corresponding to the user ID is pressed, and the succeeding processes may be executed only when the user authentication is successful.

Next, the widget information acquiring unit 133 sends a request to acquire widget information, to the widget information acquisition URL (step S204). The request to acquire widget information is received by the widget information providing unit 233 of the widget manager 22. The widget information providing unit 233 acquires widget information of all widgets registered in the widget information management table 136 corresponding to the widget information acquisition URL (i.e., the widget information management table 136 corresponding to the user operating the image forming apparatus 10), and sends a list of the acquired widget information to the image forming apparatus 10 (step S205). When sending the list of widget information items, the widget information providing unit 233 generates a URL that is unique to each of the widgets (each of the widget information items) for relaying communications between the image forming apparatus 10 and the widgets (hereinafter, “widget relay URL”). The widget information providing unit 233 adds the widget relay URL generated for each widget, to the widget information of the corresponding widget. Then, the widget information providing unit 233 sends, to the image forming apparatus 10, a list of widget information items to which the widget relay URLs have been added. Thus, each widget information item sent at step S205 may have one of the configurations illustrated in FIG. 10.

FIG. 10 illustrates a configuration of the widget information of the scan layout widget 21a sent from the widget manager 22 to the image forming apparatus 10. The widget information shown in FIG. 10 is formed by adding the widget relay URL to the widget information shown in FIG. 6, respectively. In step S205, the widget information providing unit 233 sends a list of widget information items, each widget information item having a configuration as shown in FIG. 10. The list of widget information items may include only one widget information item.

Next, the UI control unit 132 of provider application 1221 records the received list of widget information items in the RAM 112, and causes the operation panel 15 to display a screen page (widget selection screen page) including a list of widgets that can be used by the user, based on the list of widget information items (step S206).

FIG. 11 illustrates an example of a displayed widget selection screen page. A widget selection screen page 620 shown in FIG. 11 displays a button 621 corresponding to a scan layout widget 21a. If a user selects the button 621 corresponding to the scan layout widget 21a in the widget selection screen page 620, an original is set in the image forming apparatus 10 (step S207), the widget coordination unit 134 of the provider application 1221 recognizes that scanning is to be executed, based on the coordination function identifier (“scan”) included in widget information corresponding to the pressed button (hereinafter, “current widget information”). The widget coordination unit 134 requests the function control unit 135 to execute scanning.

The function control unit 135 causes the scan application 1211 to carry out a scan job based on the scan setting information of the parameters included in the current widget information (step S208). The scan application 1211 causes the scanner 12 to scan an original (hereinafter, “scan image data”), and outputs the image data obtained as a result of the scanning process to the widget coordination unit 134.

The widget coordination unit 134 sends the scan image data to a widget relay URL included in the current widget information (step S209). The image data sent to the widget relay URL is received by the relay unit 224 of the widget manager 22. Next, the relay unit 224 returns the scan image data to the collaborating unit 213a (step S121) as a response to acquire scan image data after scan image data has been received (step S115).

In response to receiving the scan image data and parameters, the collaborating unit 213a transmits the scan image data to the logic unit 214a. The logic unit 214a performs a process on the scan image data, the “logic” as will hereinafter be described in detail. The collaborating unit 213a of the scan layout widget 21a resumes polling in order to be prepared for the next operation (S155), and stands by to transmit scan image data.

The image data processed in step S122 may be not necessarily be scan image data. The image data may be from an image file stored at the user terminal 20. In this case, the image file is directly dragged and dropped onto an icon displayed by the scan lay out widget 21a, after the scan layout widget 21a actives. The scan layout widget 21a performs the logic for the image data dragged and dropped.

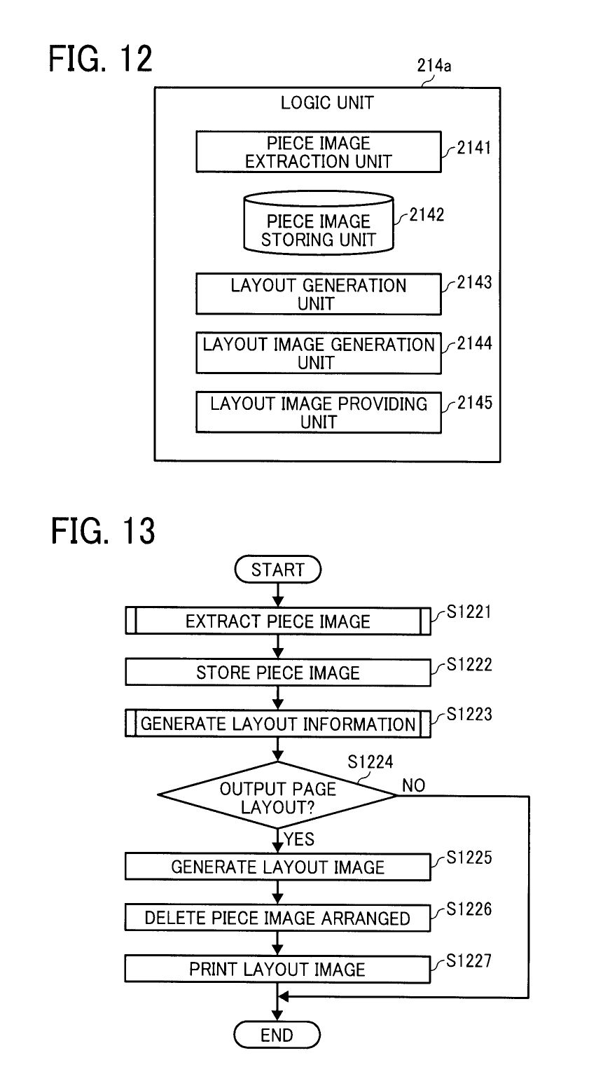

Next, a detailed description is given of the process in step S122. FIG. 12 illustrates example functional structures of the logic unit 214a of the scan layout widget. As shown in FIG. 12, the logic unit 214a includes a piece image extraction unit 2141, a piece image storing unit 2142, a layout generation unit 2143, a layout image generation unit 2144, and a layout image providing unit 2145.

The piece image extraction unit 2141 extracts a piece of image from scan image data outputted by the image forming apparatus 10. One or more piece of images is extracted from one image data. The piece image extraction unit 2141 generates image data based on a piece of image (hereinafter, “image data piece”), and stores the image data piece in the piece image storing unit 2142.

The piece image storing unit 2142 is a memory area in the secondary storage device 202 or the memory device 203 to store or to buffer the image data piece. The layout generation unit 2143 generates layout information for arranging image data pieces stored in the piece image storing unit 2142. If generated layout information satisfies a certain requirement, the layout generation unit 2143 outputs a page of layout information (hereinafter, “page layout”). On the other hand, if the layout information does not satisfy the certain requirement, the layout generation unit 2143 does not output a page layout. The certain requirement means, for example, a dimension of layout information exceeds a certain dimension by a predetermined amount (hereinafter, “output condition”). The output condition is determined based on a dimension of one page (that is to say, how the dimension the scan layout widget 21a recognizes as one-page). The dimension of one-page is specified in the scan setting information of the scan layout widget 21a (for example, A4, A5, or height and width).

The layout image generation unit 2144 generates layout image data based on the page layout. The layout image data means image data pieces arranged according to the page layout. The layout image providing unit 2145 carries out a process to output the layout image data generated by the layout image generation unit 2144. An example of the process to output may include a request to print with the printer driver 24 to the image forming apparatus 10, or to store the layout image data in a folder.

The preceding description means that if page layout is outputted using piece images from the piece image storing unit 2142, the scan layout widget 21a prints. On the other hand, the scan layout widget 21a continues to buffer image data piece until satisfying the output condition (e.g., having sufficient images to fill a page) to output a page layout.

FIG. 13 is a flowchart for describing processing procedures in a logic unit of scan layout widget. The piece image extraction unit 2141 extracts piece image data from a scan image data.

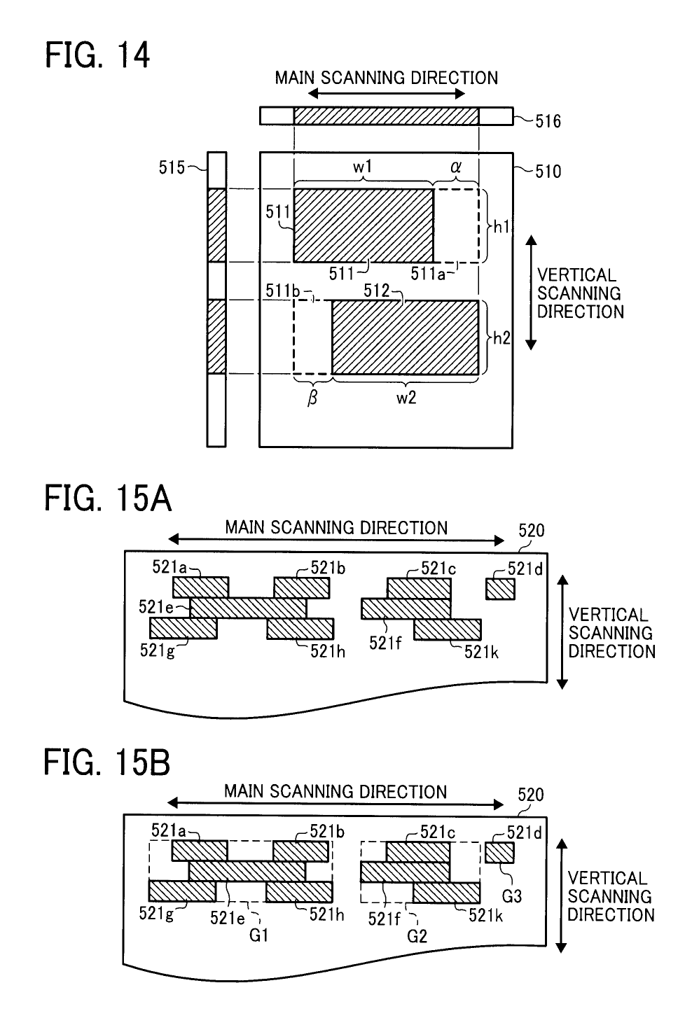

A description is given of an exemplary process used to extract piece image data. FIG. 14 illustrates a first example of a process to extract piece image data.

In a first example, scan image data is first binarized. The binarized scan image 510 includes a rectangle 511 and a rectangle 512 shown as black pixels in FIG. 14. The rectangle 511 is w1 in width and h1 in height. The rectangle 512 is w2 in width and h2 in height.

Next, the process makes a single dimension for the rectangles which are black pixels for both the main scanning direction (width) and vertical scanning direction (height). In other words, the process implements the logical OR operation to black pixels for the main scanning direction and the vertical scanning direction. As shown in FIG. 14, a range 515 and a range 516 indicate a single dimension. The range 515 means a range of black pixels of the main scanning direction. The range 516 means a range of black pixels of the vertical scanning direction.

Then, a rectangle of an overlap between the range 515 and the range 516 becomes a piece to extract for a piece of image data. Specifically, a rectangle 511a (w1+α width and h1 height) and a rectangle 511b (w2+β width and h2 height) become pieces to extract.

FIGS. 15A and 15B illustrate a second example of a process to extract pieces of image data. In the second example, scan image data is first binarized.

The process recognizes a consecutive run of black pixels in the main scanning direction (hereinafter, “black run”) from the binarized scan image 510. The binarized scan image 510 includes the black runs 521a-521k shown in FIG. 15A.

The process combines each of the black runs nearby for vertical scanning direction. FIG. 15B shows a result of combining. Specifically, a group G1 includes the black runs 521a, b, e, g, and h, and a group G2 includes the black runs 521c, f, and k. A group G3 includes only the black run 521d.

Then, a minimum rectangle including each of black runs combined as a group becomes a piece to extract for a piece image data. Specifically, a rectangle for the group G1, a rectangle for the group G2, and a rectangle for the group G3 (actually, a line for the group G3) become pieces to extract.

In another example, a piece to extract for a piece image data may be determined by the same way as processing procedures of heretofore known. For example, a rectangle as a result of the OCR (Optical Character Recognition) process on an image data may become pieces to extract.

In another example, a piece to extract for a piece image data may be specified by a user. In this case, the piece image extraction unit 2141 causes the display device 206 to display an edit screen page including a scan image data. The piece image extraction unit 2141 recognizes at least one rectangle specified in the edit screen page as pieces to extract.

In another example, a process to extract piece image data may be executed in the image forming apparatus 10. In this case, the function control unit 135 in the image forming apparatus 10 performs the process to extract piece image data from a scan image with an image data processing program installed in the image forming apparatus after step S208 shown in FIG. 8. Next, the function controlling unit 135 transmits the extracted piece image data to the widget coordination unit 134. The piece image data is then sent to the widget manager 22 in step S209. If there are plural extracted pieces of image data, the plural pieces of image data may be sent sequentially or concurrently.

Turning to FIG. 13, after starting, the piece image extraction unit generates a piece image data in step S1221, and stores the piece image data to the piece image data storing unit in step S1222. When storing, the piece image data is related to the data generated.

In another example, to extract piece image data may be not necessarily performed. In other words, scan image data may be immediately stored in the piece image storing unit 2142 as a piece image. In this case, scan image data including nonimage areas (margins) correspond to the piece image data. In this case, it is desirable when the dimension of one-page is larger than the scan image data. For example, a dimension of scan image data is a postcard size, and dimension of one-page is A4 size.

The layout generation unit 2143 generates layout information for the piece image data in the piece image storing unit 2142. If the generated layout information satisfies the output condition, the layout generation unit 2143 output a page layout in step S1223. The output condition may be based on a variety of algorithms, as will hereinafter be described in detail. However, the variety of algorithms has a common characteristic in the output condition as the dimension of layout information exceeds enough the dimensions of one-page employing each algorithm.

In the present embodiment, if the piece image data have stored enough for at least one-page, the layout image prints. The phrase “enough for at least one-page” means that it is impossible to arrange any more pieces of images in the piece image storing unit 2142 on the one-page of layout information employing the algorithm.

If the layout generation unit 2143 does not output a page layout, the process shown in FIG. 13 ends (No in step S1224). On the other hand, if the layout generation unit 2143 output a page layout (Yes in step S1224), the layout image generation unit 2144 arranges each piece of image data based on the page layout to generate one-page of image data (hereinafter, “layout image data”) in step S1225. Next, the layout image generation unit 2144 deletes the piece of image data arranged for the layout image data (that is to say, the piece image data related to the page layout) in step S1226.

The layout image providing unit 2145 causes the printer driver 24 to generate print data corresponding to the layout image data in step S1227. Specifically, the layout image providing unit 2145 activates the document application 23 corresponding to the layout image data with a command line in which the file name of the layout image data is designated as an argument, and a print process is carried out by the document application 23. As a result, the print data for the layout image data is generated by the printer driver 24.

The print data generated by the printer driver is sent to the image forming apparatus 10 via the OS 25. The print application 1212 in the image forming apparatus 10 carry out a print job based on the print data, and the layout image is printed as one-page.

The processing procedures shown in FIG. 8 and FIG. 13 from the perspective a user means that after the scan layout widget 21a is selected at an image forming apparatus 10, if the output condition is satisfied by a piece image data extracted from the scan image data, the one-page of layout image is printed on the spot. On the other hand, if the output condition is not satisfied, the piece of image data is stored in the user terminal 20 without printed.

Next, a detailed description is given of a process to generate layout information.

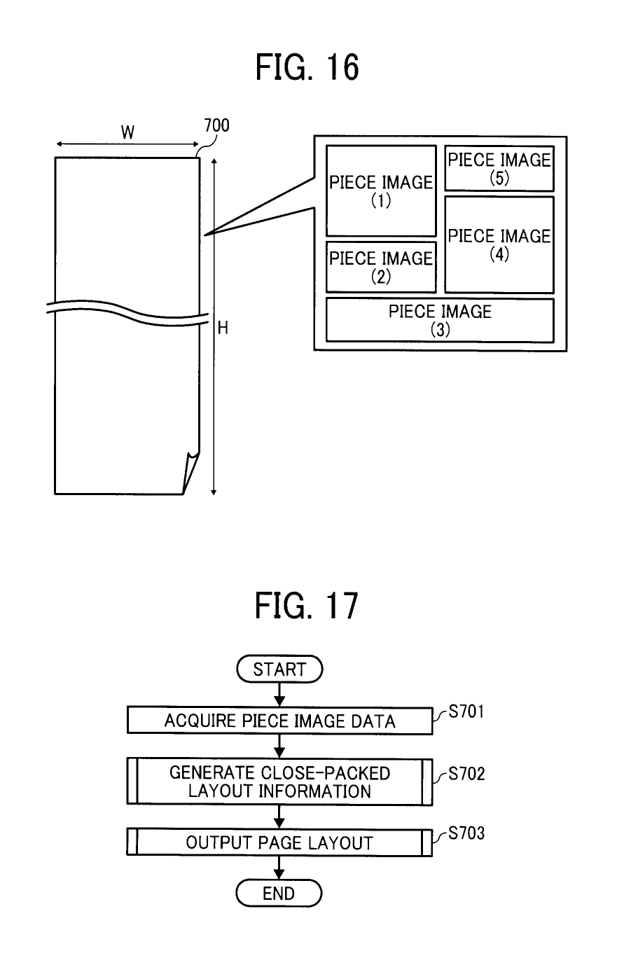

FIG. 16 illustrates an outline of a process to generate layout information. The layout generation unit 2143 generates layout information for arranging plural piece image data on an arrangement area 700 which is W width and H height. Each of the plural piece image data have several dimensions, such as width×height. On the premise that W is a finite value, and H is infinite value, the W width is determined based on a width dimension of one page specified in the scan setting information. A “layout” means arrangement of each piece of image data on the arrangement area 700. The layout information means information of arrangement for the layout of each piece image data such as ordinate and abscissa information. A “page” means an area for one page. In the present embodiment, a “page” is an area on the arrangement area 700 which is W width and a H height.

FIG. 17 is a flowchart showing processing procedures for generating layout information.

The layout generation unit 2143 acquires all piece image data in the piece image storing unit 2143 in step S701. Next, layout information is generated based on the acquired piece image data employing a close-packed algorithm in step S702 (hereinafter, “close-packed layout information” as will hereinafter be described in detail). If the generated close-packed layout information satisfies the output condition, the layout generation unit 2143 output a page layout based on the thickest layout information in step S703.

Next, a detailed description is given of step S702 shown FIG. 17. The piece image data is used to generate layout information using the following conditions:

(1) A rectangle and finite value dimension;

(2) No rotation; and

(3) No overlap with each other.

Further, step S702 arranges the plural piece image data to satisfy a minimum height. The piece image data could become omniform.

However, it is called “bin-packing problem”, and commonly believed as difficult that the condition (3), “No overlap with each other”, is practically subjected (NP-problems). Therefore, in the present embodiment, as a matter of convenience, it is assumed that the piece image data is rectangle in shape. If a piece of image data is not rectangle in shape, margins may be added, if desired to make the piece of image data rectangular.

Al algorithm may be used to generate close packed layout information. It is known that a FFDH algorithm (First-Fit Decreasing-Height) and a NFDH (Next-Fit Decreasing-Height) algorithm are basically algorithms which can achieve a close packed layout. In the present embodiment, the FFDH algorithm, for example, may be utilized. For more detail on the FFDH algorithm, refer to E. G. Coffman, JR., M. R. Garey, D. S. Johonson, R. E. Tarjan (Bell Lab. & Stanford Univ.) “Performance bounds for level-oriented two-dimensional packing algorithms”, SIAM J. Comput, vol. 9., pp 808-826, No. 4, 1980, which is incorporated herein by reference.

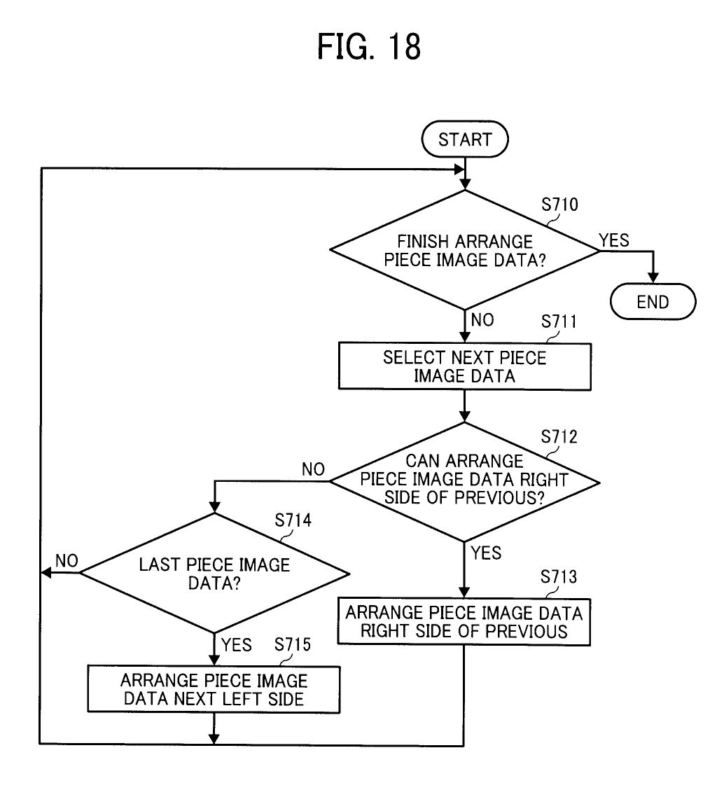

FIG. 18 is a flowchart illustrating processing procedures for arranging piece image data employing the FFDH algorithm. According to FFDH algorithm, piece image data are sorted in descending order of height, and arranged on the arrangement area 700 by the sorted height. As a matter of convenience, it is assumed that a start position to arrange becomes the top left corner of the arrangement area 700.

On that premise, it is assumed that a piece image data is arranged on the arrangement area 700 in advance, for example, first piece image data by the sorted height). The piece image data arranged in advance corresponds to a previous piece image data, and start a process of the flowchart shown in FIG. 18.

After starting, the layout generation unit 2143 determines whether all piece image data is finished being arranged. If it is not finished (No in step S710), the layout generation unit 2143 selects next piece image data for the previous piece image data (step S711). Next, the layout generation unit 2143 determines whether it is possible that the selected piece image data (hereinafter, “current image data”) is arranged on a right side of the previous piece image data (step S712). In other words, if it exceeds a width of the current image to measure a width from the right side of the previous piece image data to a right side of the arrangement area 700, it is possible for the current image data to be arranged.

If it is possible for the current image data is arranged (Yes in step S712), the layout generation unit 2143 arranges current image data next to the right side of the previous piece image data as layout information. For example, the layout information is recorded in the memory device 103. Then, the process goes back to step S710. On the other hand, if it is impossible for the current image data to be arranged in step S712, flow proceeds to step S714 in which the layout generation unit 2143 determines whether there is no next piece image data for the current image data. If there is no next piece image data (Yes in step S714), the layout generation unit 2143 selects first piece image data by the sorted height in unarranged piece image data, and arranges the selected piece image data at the bottom left corner of the piece image data arranged at the left side of the arrangement area 700 (step S715). In other words, the selected piece image data is arranged at a left side of the next block as will hereinafter be described in detail. Next, or if there is a next piece image data (No in the S714), the process goes back to step S710.

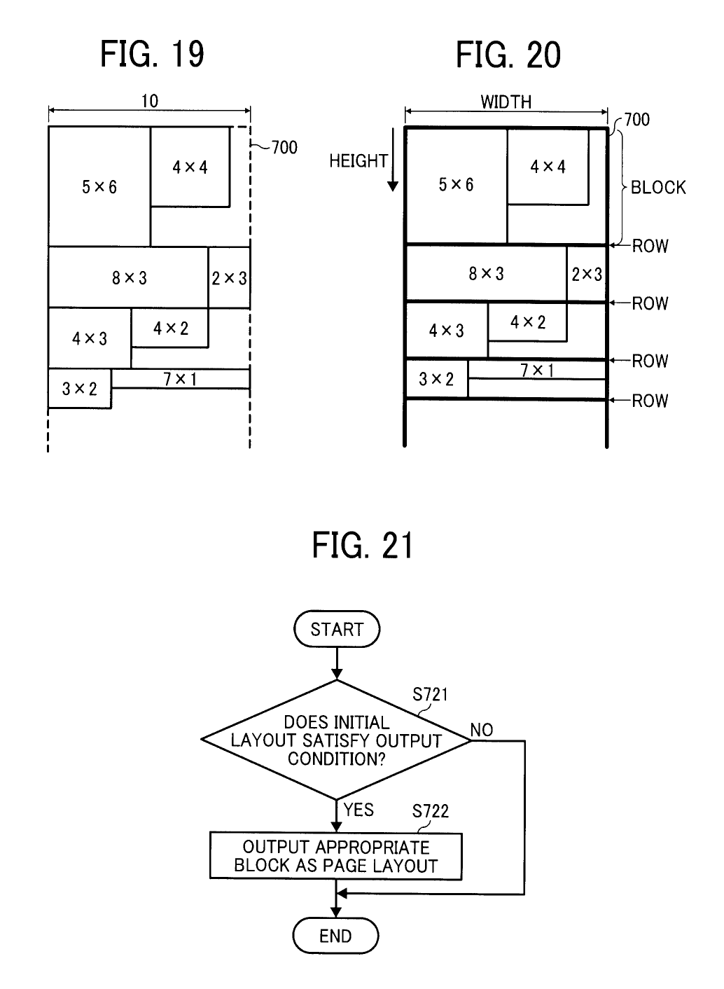

For example, piece image data are arranged as shown in FIG. 19 as a result of the process shown in FIG. 18. FIG. 19 illustrates an example of close-packed layout information arranging piece image data. Eight piece image data are arranged on the arrangement area 700 which is 10 widths (hereinafter, “initial layout”), 10 widths being in arbitrary units such as inches or centimeters, for example.

FIG. 19 and the processing procedures shown in FIG. 18 operate such that a current image, which is less than or equal to a height of the previous piece image, is arranged on the right side of the previous piece image, or is arranged on the bottom left corner of the piece image data arranged at the left side of the arrangement area 700.

As illustrated in FIG. 20, a “block” is a rectangular area containing therein piece image data. A partition between blocks is called a “row”.

FIG. 20 illustrates an example of blocks and rows based on arranging piece image data on an arrangement area. Each piece image data is arranged to align with each top of blocks shown in FIG. 20. In another example, piece image data may be arranged at other positions between rows.

Next, a detailed description is given of a process of step S703 shown in FIG. 17 of outputting a page layout with respect to FIG. 21.

The layout generation unit 2143 determines whether an initial layout satisfies an output condition in step S721. In this case, it is assumed that the output condition means there is at least a block across a two-page area of the arrangement area 700. In other words, it determines whether a length from the top of the arrangement area 700 to a bottom of last block (that is to say, last row) exceeds a height of one-page. The height of one-page is determined based on a dimension of one-page specified in the scan setting information of the scan layout widget 21a.

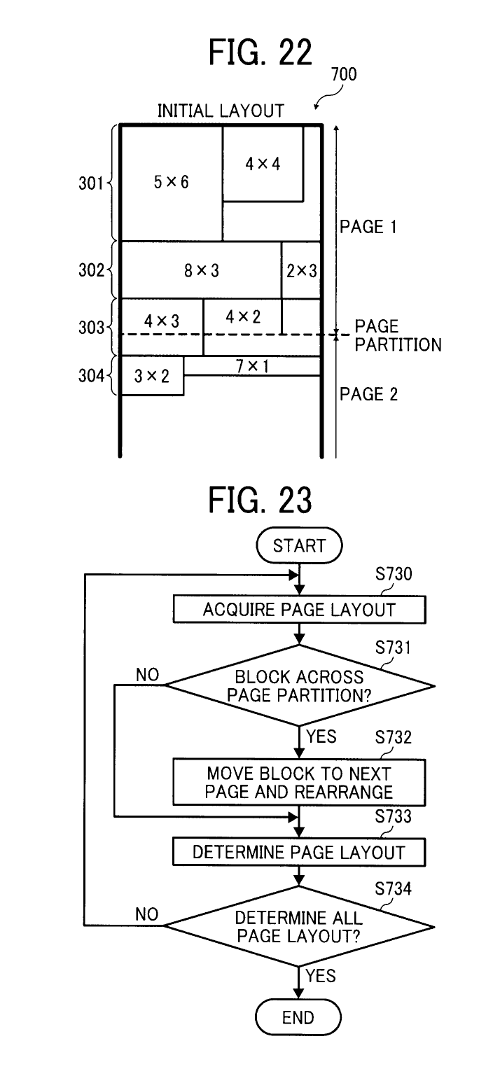

FIG. 22 illustrates an example of a block across a two-page area. Blocks 301-304 are arranged on the arrangement area 700, and a part of the block 303 is across the two-page area shown in FIG. 22. Therefore, if an initial layout corresponds to a layout shown in FIG. 22, the initial layout satisfies the output condition.

If the initial layout satisfies the output condition (Yes in step S721), the layout generation unit 2143 outputs a page layout including the information of arrangement for the layout of each piece image data on the one-page area (step S722). Specifically the page layout includes an identifier (for example, file name of the piece image data) and position information of each piece image. Once the process of FIG. 21 is started, steps S721 and/or S722 can be performed automatically and without user information.

If a piece image data included on the block across the two-page area is fitted into its own one-page area, it is assumed that the piece image data is arranged on a one-page area. For example, it is assumed that the piece image data, which is 4 widths and 2 heights, is arranged on a one-page area. Incidentally, the piece image data arranged on the one-page area is used for generating a layout image in step S1225, and is deleted from the piece image storing unit 4122 in step S1226 shown in FIG. 13.

On the other hand, if the initial layout does not satisfy the output condition, the layout generation unit 2143 does not output a page layout (No step S721).

A piece image data which is excluded from the page layout is targeted for performing a next process shown in FIG. 13 by the layout generation unit 2143.

In another example, the output condition may be that there is at least a block across an N-page area, and N may become a variable value. For example, the N-page area may be specified by the parameters of the scan layout widget 21a. If value of the N-page is ‘3’, the layout page does not output until storing piece image data enough for two pages. That means the close-packed layout information is generated based on more piece image data (buffer for double height) than the example shown in FIG. 21.

As a result, the process can generate the page layout more efficiently. In essence, the more the N-page increases, the more efficient but it may take a while to print. Therefore, the N-page may depend on a balance between the efficient a page layout and time to print the page layout.

If value of the N-pages becomes 3 or more, a page may be selected to output a targeted page layout after layout information is generated for each page based on an initial layout. The page layout may be output before performing the process shown in FIG. 21.

FIG. 23 is a flowchart for describing processing procedures when outputting a page layout. After starting, the layout generation unit 2143 acquires a targeted page layout in step S730. The targeted page layout means a layout arranging blocks included a target page from an initial layout. When the process of step S730 is initially performed, the target page is one page.

The layout generation unit 2143 determines in step S731 whether there is a block across a next-page area of the target page area (that is to say, across a page partition). If there is a block across the page partition, the block and the under block are rearrange to a top of the next page area (step S732).

Next, or if there is no block across the page partition (No in step S731), the layout generation unit 2143 fixes the target page layout to output based on current layout information. Next, the layout generation unit 2143 determines whether all page layouts are fixed on the initial layout (step S734). If there is an unfixed page layout, the target page becomes a next page corresponding to the fixed page layout, and the process goes back to step S730 to continue. On the other hand, if all page layouts are fixed, the process shown in FIG. 23 ends.

In another example, one of the page layouts may be selected to generate a layout image based on a date of the piece image data included within the page layouts. Specifically, it may generate a layout image corresponding to a one page layout including the oldest piece image data. The process can prevent scanned piece image data from not being printed for a long period of time. The oldest piece image data means a piece image data which was generated on the earliest date. In other words, the oldest piece image data means a piece image data extracted from a scanned image which the collaborating unit 213 received the fastest.

In another example, the most efficient page layout (that is to say, the highest density of a page layout) may be selected to generate a layout image. A highest density of a page layout may be calculated by a dimension of one page divided by a dimension of all piece image data or the dimension of all piece image data subtracted from the dimension of one page. In the latter case, a nonimage area (margin) is calculated. Therefore, the smaller nonimage area becomes the more efficient page layout.

In another example, plural layout images may be generated. In this example, all layout images may be forced to generate based on layout information currently in response to an instruction to print for the scan layout widget 21 by a user, even if the current layout information does not satisfy the output condition.

In the present embodiment, a block is generated based on the highest height of piece image data in the unarranged piece image data employing a close-packed algorithm. Therefore, a height of a block is less than or equal to a height of a previous block. When a certain block is across a page partition, a block may be changed with another block to fit into the page partition.

If a block is across a page partition, the process may search a block fitting into the page partition formed after the block, and bring forward the fitting block to a previous-page area. This process may be performed between steps S702 and S703 shown in FIG. 17.

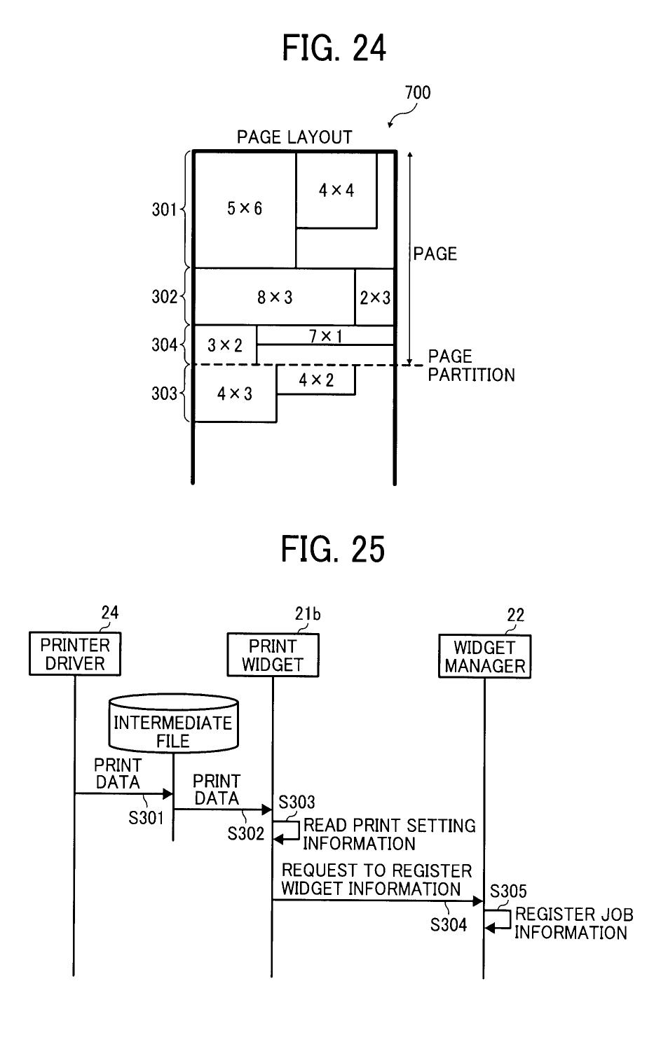

FIG. 24 illustrates an example of bringing forward the other block when a certain block is across a page partition. As shown in FIG. 24, the block 304 is changed to bring it forward in front of the block 303 across the page partition shown in FIG. 22. As a result, all piece image data included within the block 304 is fitted into the first one-page area.

In another example, the FFDH algorithm may not necessarily be employed to generate layout information by the layout generation unit 2143. The process shown in FIG. 18 may be performed by descending order of date instead of the sorted height. In this case, it may determine whether a height of the image data is shorter than the previous piece image data in addition to the current image data being arranged on a right side of the previous piece image data.

In another example, before the process shown in FIG. 13, the piece image data may be categorized into some groups depending on the image type such as a text image, a graphic image, a color image or black-and-white image, and the process shown in FIG. 13 is performed for each of the groups in parallel. The processes may be not necessarily performed in parallel, and a process shown in FIG. 17 may be performed for each group in series.

Therefore, layout images are generated based on piece image data which are of a similar image type. As a result, it is possible to perform image processing depending on the image type or to reduce toner consumption. To categorize the piece image data into groups may utilize a variety of algorithms in the same way as processing procedures of heretofore known (for example, a segmentation method).

According to the present embodiment, it is possible to efficiently and effectively output (or print) scan image data.

In the present embodiment, it is possible to generate a layout image based on mix scan image data scanned by plural image forming apparatuses 10, because the scan layout widget 21a generates a layout image. As described previously, the user can execute the scan layout widget 21a in any of plural image forming apparatuses 10 receiving the same advertisement. Therefore, the scan image data scanned by plural image forming apparatuses 10 may send same scan layout widget 21a.

Next, a description is given using FIG. 25 of an example to print layout image data by a print widget 21b in step S1227 shown in FIG. 13. At first, a basic process of the print widget 21b is described. FIG. 25 is a sequence diagram for describing processing procedures performed when registering the widget information of the print widget 21b.

When a print instruction is input into the user terminal 20a by the user who operates the document application 23, the print driver 24 generates print data related to a document data edited in the document application 23. When the logical printer corresponding to the print widget 21b is designated as a printing destination, the print driver 24 generates an intermediate file with a predetermined file name as an output destination for the logical printer in step S301.

Meanwhile, the print widget 21b waits for the generation of the intermediate file with a predetermined file name after the print widget 21b is activated. Specifically, the print widget 21b performs polling to check whether the intermediate file exists. When the print widget 21b detects that the intermediate file was generated, the print widget 21b reads print data from the intermediate file in step S302. As a result, a print job is registered to the print widget 21b.

If plural print widgets are activated in the user terminal 20, logical printers may be set up for each of the print widgets 21b, and the file names of the intermediate files output by the logic printers may be differentiated. The print widgets 21b wait for the generation of the intermediate files which are output by the logic printers corresponding to the print widgets 21b. Thus, a competition among the plural print widgets 21b relative to the same intermediate file is avoidable. The reason why the plural print widgets 21b are activated is that the print setup information pieces set up in the print widgets 21b are differentiated and the print widgets 21b to be used in response to a desired print mode are switched over. By selecting the logic printer corresponding to the print widgets 21b, it is possible to select the print widget 21b to be used.

Thereafter, the widget information sending unit 212 of the print widget 21b reads the print setting information from the attribute information management file 215b in step S303. Then, the widget information sending unit 212 sends a request to register the widget information piece including the print setting information and the print data to the widget manager in step S304. The widget information piece of the print widget 21b corresponds to attribute information for a print job registered.

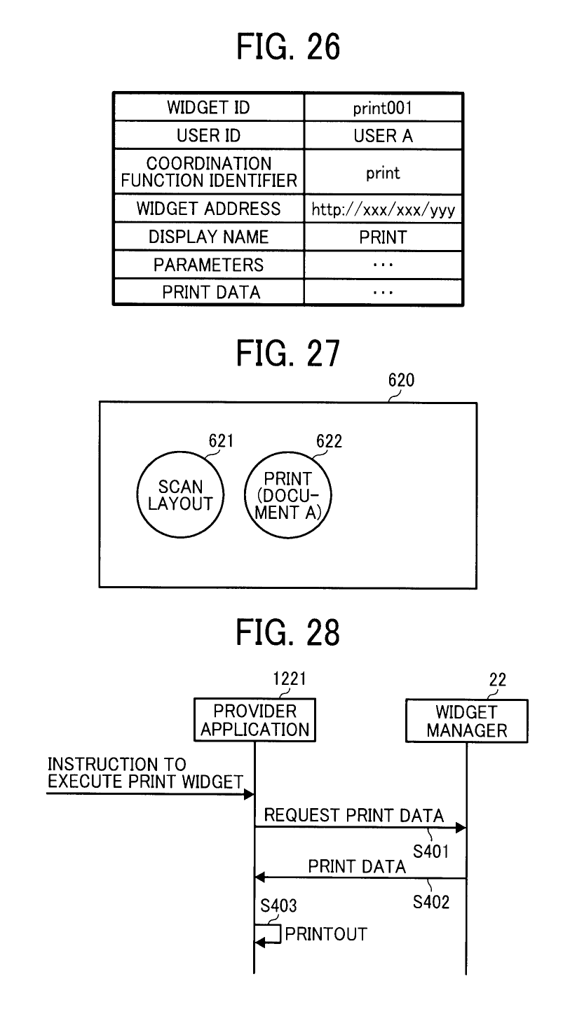

FIG. 26 illustrates an example of widget information of the print widget 21b. Substructures of widget information for the print widget 21b shown in FIG. 26 are similar substructures of widget information for the scan layout widget 21a shown in FIG. 6. However the widget information for print widget 21b includes print setting information instead of the scan setting information, and print data.

The job registering unit 221 receives the request to register the widget information piece sent by the widget information sending unit 212 of the print widget 21b print job in the step S304. The job registering unit 221 records the received widget information piece into the widget information management table 227 in step S305. If the scan layout widget 21a has already been activated, the widget information piece of the print widget 21b is also registered into the widget information management table 227 generated when the scan layout widget is activated. If an advertisement has been issued in response to the activation of the scan layout widget 21a, an advertisement relevant to same user is not issued in response to registration of the widget information of the print widget 21b. The print widget 21b resumes polling to check the intermediate file after registering the widget information.

After registering the widget information, the user moves to a location of the image forming apparatus 10 to carry out the registered print job. In a similar process to the scan layout widget 21a, the user can carry out the print job in any of plural image forming apparatuses 10 receiving the same advertisement.

A processing procedure from inputting an instruction used for displaying the user selection screen page performs a similar process as step S201-206 shown in FIG. 8. If the scan layout widget has been activated and the print job has registered a print job in the user terminal, a list of widget information sent in the step S205 by the widget information providing unit 223 includes the widget information piece of not only the scan layout widget (shown in FIG. 10) but also the print widget. The widget information piece of the print widget is formed by adding the widget relay URL to the widget information shown in FIG. 26.

In this case, the widget selection screen page in step S206 becomes a screen page shown in FIG. 27.

FIG. 27 illustrates an example of a displayed widget selection screen page when registering the print job for the print widget 21b. Common substructures to FIG. 27 and FIG. 11 have common symbols, and a description of the common parts is omitted. The widget selection screen page 620 shown in FIG. 27 displays a button 622 corresponding to the print widget 21b. The button 622 includes not only the display name of the print widget but also a name of the document data (“DOCUMENT A”) in the print job registered.

FIG. 28 is a sequence diagram for describing the process of the print widget 21b.

If the button 621 is selected in the widget selection screen page 620 and a start key on the operation panel 15 is pressed, a process shown in FIG. 28 executed.

The widget coordination unit 134 recognizes that printing is to be executed, based on a coordination function identifier (“print”) included in widget information corresponding to the selected button (hereinafter, “current widget information”). In order to execute printing, it is necessary to obtain print data. Therefore, the widget coordination unit 134 sends a request to acquire print data and print setting information (“print-data-send request”) to the widget relay URL included in the current widget information (step S401).

The print-data-send request that is sent to the widget relay URL is received by the relay unit 224 of the widget manager 22. The relay unit 224 acquires the print data and the print setting information based on widget information corresponding to the widget relay URL from the widget information management table 227. The relay unit 224 returns the acquired print data and the acquired print setting information to the widget coordination unit 134 of the provider application 1221 (S402).

The widget coordination unit 134 inputs the print data and the print setting information to the function control unit 135. The function control unit 135 causes the print application 1212 to carry out a print job based on the input print data and the input print setting information (step S403). As a result, the printer 13 outputs a sheet printed image based on the print data and the print setting information.

When a layout image is printed by the print widget 21b as described previously, the printer driver 24 may designate the print destination as a logical printer corresponding to the print widget 21b. Therefore, the printer driver 24 generates an intermediate file having a predetermined file name which is set up as an output destination to the logical printer. As a result, the process of step S302 shown in FIG. 25 is performed in response to the generation of the intermediate file.

When the layout file is a file form which can be directly printed by the image forming apparatus 10, the layout image providing unit 2145 of the scan layout widget 21a outputs layout image as the intermediate file performed polling by the print widget 21b. Also in this case, the process from step S302 shown in FIG. 25 is performed in response to the intermediate file generated.

From the perspective of users, the image forming apparatus is operated as follow.

The user inputs an instruction to use the provider application 1221. Next, the user selection screen page 610 is displayed on the operation panel 15 (reference to FIG. 9). In response to pressing a button corresponding to the user in the user selection screen page 610, the widget selection screen page 620 is displayed on the operation panel 15. The user selects the button 621 to execute the scan layout widget 21a. Again, user causes the operation panel 15 to display the widget selection screen page 620. If the output condition is satisfied and a layout image generated, the widget selection screen page 620 is displayed as shown FIG. 27. Then, if the user selects the button 622, an image forming apparatus 10 operated by the user print the layout image.

The present invention is not limited to the specific embodiments described herein, and variations and modifications may be made without departing from the scope of the present invention.

The present application is based on Japanese Priority Patent Application No. 2009-174608, filed on Jul. 27, 2009, the entire contents of which are hereby incorporated herein by reference.

1. An image processing apparatus for connection to an image forming apparatus, comprising:
a memory to store image data;
an image data receiving unit configured to receive image data, and to store the image data which has been received in the memory;
a layout generation unit configured to generate layout information for arranging plural image data in the memory according to a predetermined rule;
a layout image generation unit configured to generate layout image data which is image data arranged according to the layout information, when the generated layout information satisfies a predetermined output condition; and
a print control unit configured to register the layout image data, and cause the image forming apparatus to print the layout image data, in response to an instruction from the image forming apparatus.

2. The image processing apparatus of claim 1, wherein:
the image data receiving unit is configured to receive the image data which has been scanned by the image forming apparatus in response to an instruction.

3. The image processing apparatus of claim 2, further comprising:
an advertisement unit configured to send an advertisement to the image forming apparatus indicating that the image processing apparatus is capable of sending the layout image data.

4. The image processing apparatus of claim 2, further comprising:
an advertisement unit configured to send an advertisement to the image forming apparatus indicating that the image processing apparatus is capable of receiving the image data.

5. The image processing apparatus according to claim 1, wherein:
the predetermined output condition is satisfied when dimensions of the layout image data exceed a predetermined size.

6. The image processing apparatus according to claim 5, wherein:
the predetermined output condition is satisfied when the dimensions of the layout image data exceed a predetermine percentage of a size of a page.

7. The image processing apparatus according to claim 5, wherein:
the layout image generation unit generates the layout image data corresponding to one-page dimensions of a predetermined size.

8. The image processing apparatus according to claim 5, wherein:
the layout image generation unit generates the layout image data to include the oldest image data.

9. The image processing apparatus according to claim 5, wherein:
the layout image generation unit generates the layout image data to have a highest density in the plural pages of layout image data.

10. The image processing apparatus according to claim 1, further comprising:
an image extraction unit configured to extract plural parts of the image data, and to store one of the extracted plural parts as one image data in the memory.

11. A method of printing, comprising:
receiving image data;
storing the image data which has been received in a memory;
generating layout information for arranging plural image data in the memory according to a predetermined rule;
generating layout image data which is image data which includes image data arranged according to the layout information, when the generated layout information satisfies a predetermined output condition; and
registering the layout image data and printing the layout image data in response to an instruction from an image forming apparatus.

12. The method of claim 11, wherein:
the receiving receives the image data which has been scanned by the image forming apparatus in response to an instruction.

13. The method of claim 12, further comprising:
sending an advertisement to the image forming apparatus indicating an image processing apparatus is capable of sending the layout image data.

14. The method of claim 12, further comprising:
sending an advertisement to the image forming apparatus indicating that an image processing apparatus is capable of receiving the image data.

15. The method according to claim 11, wherein:
the predetermined output condition is satisfied when dimensions of the layout image data exceed a predetermined size.

16. The method according to claim 15, wherein:
the predetermined output condition is satisfied when the dimensions of the layout image data exceed a predetermine percentage of a size of a page.

17. The method according to claim 15, wherein:
the generating of layout image data generates the layout image data corresponding to one-page dimensions of a predetermined size.

18. The method according to claim 15, wherein:
the generating of layout image data generates the layout image data to include the oldest image data.

19. The method according to claim 15, wherein:
the generating of layout image data generates the layout image data to have a highest density in the plural pages of layout image data.

20. The method according to claim 11, further comprising:
extracting plural parts of the image data, and storing one of the extracted plural parts as one image data in the memory.
